(19) United States
(12) Patent Application Publication
(10) Pub. No.: US 2025/0256426 A1
(43) Pub. Date: Aug. 14, 2025

(54) THREE-DIMENSIONALLY FLEXURALLY DEFORMABLE SURFACE ELEMENT AND METHOD FOR PRODUCING SAME

(71) Applicant: DANZER GMBH, Baar (CH)

(72) Inventors: Thomas ECKSTEIN, Dresden (DE); Johannes GRÄSSER, Dresden (DE)

(21) Appl. No.: 18/711,664

(22) PCT Filed: Nov. 22, 2022
(86) PCT No.: PCT/EP2022/082769

§ 371 Date: May 20, 2024

(30) Foreign Application Priority Data
Nov. 23, 2021 (EP) 21209909.7

(51) Int. Cl. B27D 1/08; B27F 1/02

(52) U.S. Cl. CPC B27D 1/08; B27F 1/02

(57) ABSTRACT

In a method for producing a three-dimensionally flexurally deformable surface element (3D surface element) from wood or wood composite material, a workpiece made of wood, layered wood or a composite of wood and one or more further surface materials is used, its thickness being greater, in particular at least 5% greater, than the thickness of the 3D surface element to be produced. Narrow grooves spaced apart from one another are introduced into the workpiece, wherein the groove depth is in each case greater than or equal to the thickness of the 3D surface element and less than the thickness of the workpiece. The portion of the workpiece which exceeds the thickness of the 3D surface element to be produced is then separated from the remaining 3D surface element or otherwise processed such that there is at least temporarily no solid cohesion of the areas separated by grooves and the areas of the workpiece separated by grooves are fixed to each other and/or to a support by a transverse bond prior to, during or after separation from the workpiece, wherein at least two adjacent grooves, in particular all of the grooves, are introduced into the workpiece in such a way that at least sections exhibit an irregular undulation and/or contiguous rectilinear sections extending in different directions in a plan view of the workpiece.

The present invention relates to a method for producing a three-dimensionally flexurally deformable surface element from wood or wood composite material (3D surface element) which is suitable for producing layered two- or three-dimensional, preferably cupped (formed) pieces or for laminating other two- or three-dimensional elements or (formed) pieces made of different materials. The present invention further relates to use of the method, the three-dimensionally flexurally deformable surface element as well as a layered two- or three-dimensionally formed piece comprising the three-dimensionally flexurally deformable surface element.

A method for producing a three-dimensionally flexurally deformable surface element from wood or wood composite material for producing formed parts is known from DE 101 24 913 C1, in which a workpiece made of wood, layered wood or a composite of wood and one or more further surface materials is used, its thickness being at least 5% greater than the thickness of the 3D surface element to be produced, wherein narrow grooves spaced apart from one another are introduced into the workpiece, wherein the groove depth is in each case greater than or equal to the thickness of the 3D surface element and less than the thickness of the workpiece. The portion of the workpiece which exceeds the thickness of the 3D surface element to be produced is then separated from the remaining 3D surface element or otherwise processed such that there is at least temporarily no solid cohesion of the areas separated by grooves and the areas of the workpiece separated by grooves are fixed to each other and/or to a support by a transverse bond prior to, during or after separation from the workpiece.

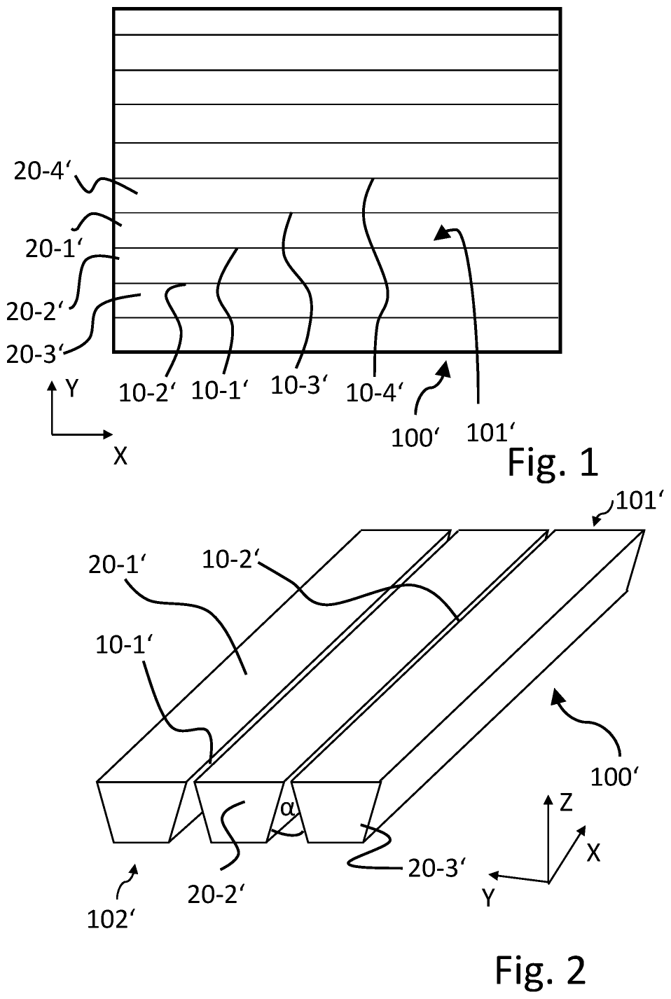

FIG. 1 illustrates a plan view of a visible side 101′ of a three-dimensionally flexurally deformable surface element or formed piece produced using the method known from DE 101 24 913 C1, and FIG. 2 illustrates a perspective cross-sectional view of a section of the three-dimensionally flexurally deformable surface element or formed piece shown in FIG. 1. As illustrated in FIGS. 1 and 2, the grooves, which are to be seen or respectively formed at least in sections in the finished three-dimensionally flexurally deformable surface element 100′ or formed piece as joints 10-1′, 10-2′, 10-3′, 10-4′ between wooden strips 20-1′, 20-2′, 20-3′, 20-4′ are introduced into the workpiece straight and parallel to one another from a rear side of the workpiece or from the visible side 101′. The rear side 102′ of the three-dimensionally flexurally deformable surface element 100′ schematically depicted in FIG. 2 can be formed by or comprise a transverse bond not illustrated in FIG. 2, wherein the rear side of the workpiece can correspond to the rear side 102′ of the three-dimensionally flexurally deformable surface element 100′ without the subsequently applied transverse bond.

In consequence of such a design to the grooves or joints 10-1′, 10-2′, 10-3′, 10-4′ of the three-dimensionally flexurally deformable surface element 100′ or formed piece respectively, an observer can recognize that the surface or respectively visible side 101′ of the three-dimensionally flexurally deformable surface element 100′ is not the surface of a continuous piece of wood. These parallel joints thereby stand out particularly distinctly to the observer since the human eye is inclined to look for, recognize and also complete patterns. The observer perceives this conspicuity as distracting and quality-diminishing in formed pieces made from 3D surface elements. This effect particularly comes to light in wood/veneer varieties in which, due to their structure, the fibers of the wood greatly deviate from a straight line, particularly in the case of burl veneers such as walnut burl veneer, root veneer, veneers with knots, wavy-grained wood and natural or engineered fiddleback textures. Furthermore, using the method known from DE 101 24 913 C1 to produce a three-dimensionally flexurally deformable surface element from such types of wood/veneer results in wood fibers which are in part cut crosswise or at an angle, whereby there is a tendency to split and/or the wood fibers can splinter.

It is a task of the invention to provide a three-dimensionally flexurally deformable surface element as well as a method for its production which is able to achieve a surface structure for the surface which is better adapted to a natural surface of a continuous piece of wood and is able to reduce risk of damage to the three-dimensionally flexurally deformable surface element during or after its production.

These tasks are solved by the features of the independent claims. Further preferential embodiments of the invention constitute the subject matter of the dependent claims.

According to one embodiment of a method for producing a three-dimensionally flexurally deformable surface element (3D surface element) from wood or wood composite material, a workpiece made of wood, layered wood or a composite of wood and one or more further surface materials is used, its thickness being greater, in particular at least 5% greater, than the thickness of the 3D surface element to be produced. Narrow grooves spaced apart from one another are introduced into the workpiece, wherein the groove depth is in each case greater than or equal to the thickness of the 3D surface element and less than the thickness of the workpiece. The portion of the workpiece which exceeds the thickness of the 3D surface element to be produced is then separated from the remaining 3D surface element or otherwise processed such that there is at least temporarily no solid cohesion of the areas separated by grooves and the areas of the workpiece separated by grooves are fixed to each other and/or to a support by a transverse bond prior to, during or after separation from the workpiece, wherein at least two adjacent grooves, in particular all of the grooves, are introduced into the workpiece in such a way that at least sections exhibit an irregular undulation and/or contiguous rectilinear sections extending in different directions in a plan view of the workpiece.

The 3D surface element produced by the inventive method is in particular provided for the production of layered two- or three-dimensional formed pieces or for the laminating of two- or three-dimensional formed pieces. According to the invention, at least two adjacent grooves, in particular all of the grooves, are introduced into the workpiece, particularly into a rear side of the workpiece opposite from a visible side of the finished three-dimensionally flexurally deformable surface element, or into the visible side such that at least sections exhibit an irregular undulation and/or contiguous rectilinear sections extending in different directions in a plan view of the workpiece. The grooves are in particular introduced into the workpiece so as to not run parallel to each other. Since at least sections of the grooves, at least sections of which have an irregular undulation and/or contiguous rectilinear sections extending in different directions, are not visible or at least much less visible as joints between strips of wood on the visible side in the three-dimensionally flexurally deformable surface element produced using the inventive method, and ultimately the formed piece produced using the three-dimensionally flexurally deformable surface element, this achieves a surface structure of the surface element/formed piece which is adapted to a natural surface of a continuous piece of wood.

According to one embodiment, the at least two adjacent grooves are introduced into the workpiece such that a spacing of the at least two adjacent grooves measured in a width direction of the grooves varies along a longitudinal direction of the grooves.

In one preferential embodiment, the grooves are introduced into the workpiece in such a way that there is an angle β in the range of −15°<β<+15°, preferably in the range of −5°<β<+5°, between a local normal of each groove and a respective normal of a virtual straight line associated with the respective groove at each point of the respective groove, for example in the case of the workpiece having (wood) fibers exhibiting greatly differing orientations such as occurs in burl wood. In so doing, the respective virtual lines extend on the visible side of the finished three-dimensionally flexurally deformable surface element which may not be exposed at the time the grooves are introduced.

According to one embodiment, the grooves are introduced into the workpiece such that over the entire length of the groove, there is a distance between each groove and a respective virtual straight line associated therewith of less than 30%, preferentially less than 20%, particularly preferentially less than 10%, of a distance between the virtual straight line associated with the respective groove and a virtual straight line associated with an adjacent groove of the respective groove.

According to one embodiment, the grooves are introduced into the workpiece such that sections of different grooves extending in the longitudinal direction and corresponding to one another in the longitudinal direction are of different shape in the plan view of the workpiece.

In one preferential embodiment, the grooves are introduced into the workpiece by means of scoring blades and/or roller blades and/or at least one laser and/or waterjet cutting using a jet of water and/or machining, in particular sawing and/or milling, with a machining tool.

According to one embodiment, the scoring blades and/or the roller blades are configured so as to be passively deflected and/or passively twisted during the introduction of the grooves into the workpiece subject to a hardness of the corresponding workpiece section and/or a local course of the wood fibers in said section of the workpiece, and/or a position and/or orientation of the scoring blades and/or the roller blades and/or a mount of the scoring blades and/or the roller blades is passively changed during the introduction of the grooves into the workpiece subject to the hardness of the corresponding section of the workpiece and/or the local course of the wood fibers in said section of the workpiece and/or actively changed in order to produce the at least sectionally irregularly undulating shape of the grooves or contiguous rectilinear sections of the grooves extending in different directions in the plan view of the workpiece respectively by the passive deflection and/or twisting of the scoring blades and/or the roller blades and/or the active or passive changing of the position and/or orientation of the scoring blades and/or the roller blades and/or the mount of the scoring blades and/or the roller blades.

Preferably, the local and/or global course of the wood fibers is determined prior to the grooves being introduced into the workpiece. For example, the local and/or global course of the wood fibers can be determined here by capturing an image of the workpiece using an image capturing device, e.g. a camera, and processing/analyzing the captured image using image processing software, particularly as regards the positional orientation of the medullary rays in the case of rotary cut veneer made of beech wood, in order to calculate or respectively determine the local and/or global course of the wood fibers. Furthermore, the local and/or global course of the wood fibers can be determined by breaking off a part of the workpiece prior to the grooves being introduced. In this case, the local and/or global course of the wood fibers can be determined on the basis of the cleft edge, the course of which corresponds to the local and/or global course of the wood fibers. In addition, the local and/or global course of the wood fibers can be determined by determining the strength/stability of the workpiece/wood in different directions, for example by means of flexing the workpiece under a predetermined load on the wood. In particular able to be utilized in the process is the fact that the strength/stability of the workpiece/wood is highest under a transverse load on the wood fibers whereas the strength/stability of the workpiece/wood is lowest in the same or respectively parallel direction to the wood fibers. Thus, the workpiece/wood will bend less upon a transverse load on the wood fiber; i.e. when the bend axis is orthogonal to the orientation of the wood fibers, than when loaded along the direction taken by the wood fibers, whereby the course of the wood fibers can be determined upon the workpiece/wood being subjected to corresponding loads.

After determining the local and/or global course of the wood fibers, the workpiece can be positioned relative to the corresponding tool with which the grooves are introduced into the workpiece such that the grooves to be introduced substantially follow the local and/or global course of the wood fibers.

The passive deflection of the scoring blade or roller blade is defined by a deflection from its rest position as a result of an interaction between the workpiece and the scoring blade or roller blade. In particular, with a fixed scoring blade/roller blade position and orientation, the passive deflection of same can be defined by a distance between a respective virtual straight line and the corresponding actually generated groove, measured along the width direction of the groove. A passive twisting of the scoring blade or roller blade, given it or its mount having a fixed position and orientation, refers to an (elastic) (torsional) deformation induced by a force acting on the scoring blade or roller blade. An “orientation” of the scoring blade or roller blade refers to an orientation or respectively an angle of a section of same provided for producing the groove relative to a plane perpendicular to the surface of the workpiece into which the groove is to be introduced. A change in the orientation of the mount of the scoring blade/roller blade is to be understood as a change in its rotational angle relative to the plane perpendicular to the surface of the workpiece into which the groove is to be introduced.

“Passive deflection of the scoring blade and/or roller blade,” “passive twisting of the scoring blade and/or roller blade” and “passive changing of the position and/or orientation of the scoring blade and/or roller blade and/or the mount of the scoring blade and/or roller blade” does not hereby mean that the deflection, twisting and/or changing of the position and/or orientation occurs arbitrarily or randomly. Rather, “passive” is to be understood as the respective blade being subjected to the given conditions at the point in time the groove is introduced into the workpiece and reacting to same by creating a groove in the workpiece with an irregular undulation and/or contiguous sections extending in different directions. “Given conditions” refers to the hardness as well as the run of the grain of the corresponding section of the workpiece.

The hardness of the corresponding workpiece section can thereby be determined by wood type, wood species mix in the case of layered surface composites the workpiece comprises, local bulk density of the workpiece, which is for example higher in the area of a branch than in other areas, and/or degree of plasticization of the workpiece or the wood thereof, which can vary by wood moisture and/or temperature of the workpiece. Furthermore, the run of the corresponding section's grain can be determined by characteristics of the wood (including growth anomalies) such as, for example, branch base occlusions, spiral or wavy growth, the tree's location, the presence of branches with wood fiber running differently, in particular perpendicular, to the wood fiber surrounding the branch and/or the length of the wood fiber, which is about 10 mm for hardwood and about 50 mm for softwood.

The joints contained in the formed piece ultimately produced using the three-dimensionally flexurally deformable surface element are thereby at least highly visible when the course of the introduced grooves, and thus of the joints, follows the run of the grain dictated by the wood as closely as possible. Yet there is only a certain degree to which this “following” is possible. If the resistance formed by the cutting force to be realized and the deflection of the blade becomes too high, the blade will not align with the grain and will form the groove in a correspondent different place.

According to one embodiment, a hardness of the scoring blades and/or the roller blades, in particular of a material thereof, and/or a material strength of the scoring blades and/or the roller blades and/or a free length of the scoring blades and/or roller blades and/or a cutting edge geometry, particularly an edge angle and/or bevel angle of the scoring blades and/or roller blades, and/or a ductility and/or an elasticity and/or a resilience of the scoring blades and/or the roller blades and/or an inclination angle of the scoring blades and/or roller blades with respect to the workpiece and/or one or more materials from which the scoring blades and/or roller blades are formed, and/or the position and/or the orientation of the scoring blades and/or roller blades and/or the mount of the scoring blades and/or roller blades when the grooves are introduced into the workpiece depending on type of wood and/or the hardness of the corresponding workpiece section and/or the local course of the wood fibers in said workpiece section and/or a global course of the wood fibers and/or a degree of plasticization of the wood of the workpiece is actively selected such that during the introduction of the grooves into the workpiece, the scoring blades and/or the roller blades are passively deflected and/or twisted, substantially within known limits, particularly within permissible limits determined by a material of the workpiece and properties of a tool comprising the scoring blades and/or roller blades and with which the grooves are introduced into the workpiece, and thus in particular follow the course of the wood fibers. The scoring blades/roller blades in particular only follow the course of the wood fibers to a certain extent at which the movement of the scoring blades/roller blades is prevented from further following by means of being fixed by the mount or blade holder which holds one or more of the scoring blades/roller blades and/or a stabilization device designed for example as a sleeve and/or comprising clamping jaws in order to limit the free length of the scoring blades or roller blades. In the event of impermissible deviations, the wood fiber is then cut through.

This thereby in particular makes use of the fact that the hardness of different wood fibers of the wood or within a single wood fiber itself is not homogeneous and the scoring blades/roller blades substantially follow the least resistance and are accordingly deflected and/or twisted when the grooves are being introduced. In particular the deflection of the blade (scoring blade or roller blade) as well as its twisting during the introduction of the groove substantially align with the run of the wood grain of the workpiece to be machined, whereby a groove formed substantially in correspondence with the grain is produced.

This design additionally has the advantage of being able to increase the operating life of the scoring blades/roller blades compared to a case in which the scoring blades and/or roller blades are of higher hardness such that they are not deflected and/or twisted during the introduction of the grooves into the workpiece as the lower hardness of the scoring blades/roller blades reduces risk of the scoring blades/roller blades breaking. Moreover, the cutting force of the scoring blades and/or roller blades required to introduce the grooves into the workpiece is considerably lower when the grooves are introduced into the workpiece commensurate with the grain of the wood or following the grain of the wood than when the fibers are cut as the grooves are being introduced into the workpiece. The grooves are thereby in part introduced by the splitting of the workpiece due to of a wedge-shaped cross section of the blade of the scoring blades and/or roller blades in the width direction of the grooves such that the tip of the scoring blades and/or roller blades is thinner than other sections of the scoring blades and/or roller blades farther away from the tip so that sections near the tip are subjected to less stress when the grooves are introduced than sections farther away from the tip.

According to one embodiment, the position, in particular perpendicular to the virtual straight line, and/or the alignment of the scoring blades and/or the roller blades and/or the mount of the scoring blades and/or roller blades and/or a position and/or alignment of the laser and/or the water jet and/or the machining tool is additionally actively changed as the grooves are being introduced into the workpiece, in particular using a motor, particularly a servomotor and/or stepper motor, and/or an eccentric in order for the additional active change to at least contribute to at least sections of the grooves exhibiting an irregular undulation and/or contiguous rectilinear sections extending in different directions in a plan view of the workpiece.

According to one embodiment, the grooves are introduced into the workpiece by means of scoring blades and/or roller blades, the blades of which are wedge-shaped in cross section, in particular along a width direction of the groove to be introduced, such that at least two adjacent scoring blades and/or roller blades have a different penetration depth into the workpiece.

In so doing, grooves of different width can be created in the workpiece on the visible side of the three-dimensionally flexurally deformable surface element to be produced. Due to lower frictional forces and/or greater free length of the corresponding section of the transverse bond, adjacent strips of wood separated by a groove or joint of larger width can thereby be more easily displaced against each other than strips of wood separated by a groove of smaller width.

According to one embodiment, a cutting speed, which is determined by a speed of a relative movement between the workpiece and a mounting position of the tool with which the grooves are introduced into the workpiece, is determined as a function of the type of wood and/or the degree of plasticization of the wood and/or a global run of the (wood) grain of the wood of the workpiece. Thus, for example, a higher cutting speed can be used for a type of wood of lesser hardness than for a type of wood of greater hardness. In addition, a higher cutting speed can be used in the case of a high degree of plasticization of the wood than in the case of a comparatively lower degree of plasticization. Furthermore, a lower cutting speed can be used in the case of a global grain which deviates significantly from a straight direction than is the case with a global grain deviating less from the straight direction.

In one embodiment, the grooves are introduced substantially longitudinally along the direction of the grain.

According to one embodiment, the grooves are introduced into the workpiece such that a distance measured in the width direction of the grooves from adjacent virtual straight lines associated with respectively adjacent grooves is in the range of 0.1 to 100 mm, preferably in the range of 0.5 to 3.5 mm, particularly preferentially in the range of 0.7 to 1.3 mm. The grooves thereby divide the 3D surface element into strips 0.1 to 100 mm (or 0.5 to 3.5 mm or 0.7 to 1.3 mm) wide. The strips are displaceable relative to each other and the surface element thus three-dimensionally deformable.

According to one embodiment, the grooves are introduced in a V-shape. The introduced V-shaped grooves can thereby have an opening angle α of 0°<α≤25°, preferably 0°<α≤20°, further preferably 0°<α≤15°. The grooves can also exhibit a profile deviating from the V-shape.

According to one embodiment, the grooves are introduced with scoring blades or roller blades which are preferably moved substantially longitudinally along the direction of the grain relative to the workpiece. Significant here is a relative movement between the blade and the workpiece. The blades, which have a lower thickness limitation for stability reasons, can be arranged in two or more rows offset one behind the other so as to achieve the low groove spacing. This offset is also advantageous in that the displacement of the material to be machined as the blades penetrate can be dispersed over several times the respective width of the groove, thereby reducing the cutting forces.

The remaining cohesion of the strips achieves stability of the workpiece, particularly during the strip cutting phase, so that even diagonally grained wood can be processed unproblematically.

According to one embodiment, the areas of the workpiece divided or separated by grooves are fixed by means of a transverse bond prior to the separation of the 3D surface element.

The transverse bond is preferably produced before the material is separated by applying a shear-deformable and/or reversibly reinforcing material such as individual filaments, a multifilament yarn or the like coated with adhesive, a woven material, a nonwoven material, a film or an adhesive layer. The transverse bond can thereby be applied in such a way that an angle between the (main) direction of extension of the transverse bond and the virtual straight line is in a range of between 0° and 90°. Preferably, the angle between the main direction of extension of the transverse bond and the virtual straight line is approximately 90° since at this angle the displaceability between the areas separated by the grooves, i.e. the adjacent strips of wood, is approximately the same in both directions along the grooves or substantially along the virtual straight line respectively. In one embodiment, the angle between the main direction of extension of the transverse bond and the virtual straight line can be less than 90°, e.g. 45°. In this case, displaceability along the grooves is substantially blocked in one direction while the displaceability can be increased in the other direction, for example in comparison to the displaceability at a 90° angle.

The transverse bond can also be realized after the described material has been separated, wherein between the phase of separation and the application of the transverse bond, the strips must be guided in a manner that preserves the surface.

A transverse bond by means of an applied material enables the shear deformation of the strips by virtue of its material-related shear deformability and/or the deformability of the adhesive layer.

When the workpiece consists of layered wood, the stability of the strips of the separated 3D surface element is increased additionally to the described transverse bond by the sealing effect of the layers such that even extremely diagonally grained or brittle starting material like mahogany or burl wood can be safely processed into a 3D surface element. This sealing effect occurs when layers of wood (veneers) are deliberately layered crosswise to one another but also when layers are layered parallel to the direction of the wood fibers as there is virtually always a deviation from the assumed fiber direction and hence a certain degree of criss-crossing.

The same sealing effect, particularly also for diagonally grained wood, occurs when using a further temporary support for layering arranged in the workpiece on the visible side of the finished three-dimensionally flexurally deformable surface element. Using the temporary support enables additional stabilizing of the underlying wood layers, particularly in the direction transverse to the wood fibers, during the introduction of the grooves. Furthermore, using the temporary support can reduce production costs compared to variants without a temporary support in that, for example, a potentially more expensive material such as a thick walnut veneer is replaced by a more economical thinner walnut veneer and a more economical temporary support such as cardboard.

The temporary support can in particular be a surface material such as a plastic film, a cardboard, a paper, particularly a kraft liner, a metal layer/film, a wood material, a nonwoven material, particularly a nonwoven mat, in particular an annual plant-based nonwoven mat, or a non-woven fabric or other flat materials.

Should the tool for introducing the grooves thereby pierce the temporary support from the reverse side of the workpiece and the material or materials of the temporary support into which the tip of the tool penetrates when the grooves are introduced is softer than the material or materials of the section of the workpiece on the opposite side from the visible side, the tip of the tool piercing the temporary support is subjected to less stress than a section of the tool penetrating up to but not into the temporary support when the grooves are introduced into the workpiece.

In the case of a non-layered workpiece, an area of the workpiece wood arranged on the visible side of the finished three-dimensionally flexurally deformable surface element can also function as a temporary support.

Instead of or in addition to the temporary support, its supporting effect can also be achieved by providing auxiliary energy in the fixing of a position of workpiece parts, in particular the strips of wood, for example by clamping and/or applying a vacuum.

According to one embodiment, the portion of the workpiece that exceeds the thickness of the 3D surface element to be produced, in particular when the starting workpiece is only slightly thicker than the 3D surface element (for example a piece of veneer), is separated by means of grinding off the remaining material. The grooves are thereby made continuous and the desired 3D deformability achieved. In the case of 3D surface elements made of sliced or rotary cut veneer, grinding the surface is necessary anyway when same is used as a top layer in a formed piece such that this process step does not entail any additional effort. Instead of grinding, other ablative and thus smoothing processes are also possible such as, for example, planing by means of draw blades or longitudinal cutting (finishing). The already produced transverse bond between the strips stabilizes the workpiece during the separating and allows the finished 3D surface element to be handled just like normal wood veneer.

Filling the grooves with adhesive, in particular hot melt adhesive, in order to produce the transverse bond according to one embodiment creates a sealing effect, whereby the risk of glue bleeding through during subsequent layer bonding as well as capillary penetration of liquid surface tempering materials such as varnishes and stains into the joints on the finished formed piece which have solidified after 3D deformation is prevented. This thereby eliminates unwanted visual emphasis of the joints. The solidified joints moreover increase the rigidity and particularly the torsional stiffness of the finished formed piece.

If the workpiece is significantly thicker than the 3D surface element to be produced (e.g. a solid wood scantling), the remaining material is to be separated as a block. To facilitate a better understanding, this should be phrased as separating the 3D surface element from the block, the operating principle remains the same. This can ensue via conventional separating processes such as sawing, but advantageously also occurs by means of slicing such as, for example, via longitudinal cutting in the manner of veneer production, e.g. with a finishing machine. The separation of 3D surface elements from this block can be repeated with each new groove until the entire block is processed. Since finishing creates a very smooth surface, grinding is no longer necessary here. The transverse bond of the strips provides the same advantages as when separating off by grinding.

According to another embodiment, the portion of the workpiece that exceeds the thickness of the 3D surface element to be produced is separated off by shearing, scraping, rolling or stripping off a support layer provided for the purpose and only secured by adhesive bonding. Such a support layer can comprise a plastic film, a cardboard, a paper, particularly a kraft liner, a metal layer/film, a wood material, a nonwoven material, particularly a nonwoven mat, in particular an annual plant-based nonwoven mat, or a non-woven fabric or other flat materials as well as a plastic and, if necessary, can be reused multiple times after being appropriately treated. However, it can also remain on the 3D surface element as a protective film during subsequent transport and storage up until further processing, which is advantageous in the case of particularly valuable materials such as burl veneer.

Instead of cutting off the material exceeding the thickness of the 3D surface element, e.g. a plastic film, it can also be softened, for example by melting, which likewise results in the desired displaceability of the strips. The particular advantage here is the possibility of being able to use this plastic film to immediately treat the surface of the subsequent outer surface of a formed piece to which the 3D surface element is laminated.

According to one embodiment, the three-dimensionally flexurally deformable surface element made from grooved and ground veneer is used as a decorative top layer veneer and/or a core material/inner layer veneer without decorative requirements in the production of laminated wood formed pieces for chairs, armchair shells, interior fittings for vehicles, cases, containers such as suitcases, bins or boxes, musical instruments, housings for electronic equipment, loudspeakers, toys or sporting goods.

According to another embodiment, the three-dimensionally flexurally deformable surface elements are used for laminating the fronts of furniture made of chipboard or fiberboard or circular table top profiles or automotive interior panels or control elements such as steering wheels made of plastic or metal parts or aircraft interior panels made of lightweight plastic elements.

According to one embodiment, the moisture content of the wood of the material or the 3D surface element is adjusted to a wood moisture of more than 10%, in particular about 12%-22%, prior to its production. A fungus-inhibiting substance or other additives can be applied when moistening the material or the 3D surface element, whereby the 3D surface element can be brought into a state suitable for storage without becoming fungal-ridden. Furthermore, the moistening makes for substantially better deformability of the 3D surface element since the individual strips can be bent in smaller radii than at normal equilibrium moisture content. This effect can be further increased if additional heating occurs prior to the 3D deformation.

According to one embodiment, the high water content is reduced to the usual level during a subsequent hot pressing into the 3D formed piece. The thusly improved yieldability of the 3D surface element closes any cracks, gaps, etc. that may occur during the pressing process. Should there already be an increased wood moisture prior to the 3D surface element being produced, the cutting forces required thereto are reduced, coupled with reduced tool wear or increased tool service life respectively.

According to one embodiment, a fire-retardant substance is introduced during the moistening of the material or the 3D surface element.

Instead of the increased wood moisture, the 3D surface element is in one embodiment pretreated prior to its production with wood plasticizers such as, for example, ammonia, whereby comparable advantages are achieved as with moisture treatment.

According to one embodiment, the 3D surface element is treated with an impregnating resin. Such a resin penetrates into the interior of the wood structure yet also moistens the surface of the strips of the 3D surface element. The resin is regulated such that it liquefies when heated prior to the 3D deformation and thus enables the strips of the 3D surface element to be displaced. Additionally advantageous to the known improvement in water resistance of impregnated wood is the reversible bonding of the strips of the 3D surface element which occurs with impregnation.

According to one embodiment, a method as described above is used for producing a layered two- or three-dimensionally formed piece or for laminating a two- or three-dimensionally formed piece. Furthermore, using the 3D surface element produced by means of the inventive method also enables the producing and/or laminating of flat materials or 2D formed pieces. It is additionally possible to warp the surface of a 3D surface element produced using the inventive method; i.e. alter the surface of the 3D surface element, in order to obtain a modified 3D surface element. In this case, the joints follow the contour along which the 3D surface element was warped. The modified 3D surface element can then be used to produce a two- or three-dimensionally curved formed piece or to laminate a two- or three-dimensionally formed piece.

According to one embodiment, a three-dimensionally flexurally deformable surface element (3D surface element) from wood or wood composite material which is able to be produced in particular by an above-described method for producing a three-dimensionally flexurally deformable surface element (3D surface element) from wood or wood composite material comprises a plurality of strips of wood, layered wood or a composite of wood and one or more further surface materials which are fixed to one another and/or to a support by a transverse bond and separated by joints, wherein at least sections of at least two adjacent joints, in particular all of the joints, exhibit an irregular undulation and/or contiguous rectilinear sections extending in different directions in a plan view of the three-dimensionally flexurally deformable surface element.

According to one embodiment, a spacing of the at least two adjacent joints measured in a width direction of the joints varies along a longitudinal direction of the joints.

According to one embodiment, there is an angle β in the range of −15°≤β≤+15°, particularly in the range of −5°≤β≤5°, between a local normal of each joint and a respective normal of a virtual straight line associated with the respective groove at each point of the respective joint.

According to one embodiment, a distance between each joint and a respective virtual straight line associated therewith is less than 30%, preferentially less than 20%, particularly preferentially less than 10%, of a distance between the virtual straight line associated with the respective joint and a virtual straight line associated with an adjacent joint of the respective joint over the entire length of the joint.

According to one embodiment, the sections of different joints extending in the longitudinal direction and corresponding to one another in the longitudinal direction are of different shape in the plan view of the three-dimensionally flexurally deformable surface element.

According to one embodiment, the joints run substantially longitudinal to the grain direction.

According to one embodiment, a distance measured in the width direction of the joints from adjacent virtual straight lines associated with respectively adjacent joints is in the range of 0.1 to 100 mm, preferably in the range of 0.5 to 3.5 mm, particularly preferentially in the range of 0.7 to 1.3 mm.

According to one embodiment, the joints are of V-shaped design, wherein an opening angle α of the V-shaped joints can amount to 0°<α≤25°, preferably 0°<α≤20°, further preferably 0°<α≤15°.

According to one embodiment, the transverse bond contains a shear-deformable and/or reversibly reinforcing material such as individual filaments, a fabric, a nonwoven material, a film or an adhesive layer, wherein the adhesive can be a reactivatable, e.g. heat-reactivatable, adhesive (hot melt adhesive) and/or a light-resistant adhesive and/or fire-retarding adhesive.

A layered two- or three-dimensional formed piece according to one embodiment comprises at least one three-dimensionally flexurally deformable surface element (3D surface element) as described above.

Further advantageous developments derive from the following description of preferential embodiments. Shown here, partly schematically:

FIG. 1 a plan view of a three-dimensionally flexurally deformable surface element produced using a conventional process,

FIG. 2 a perspective cross-sectional view of a section of the three-dimensionally flexurally deformable surface element shown in FIG. 1,

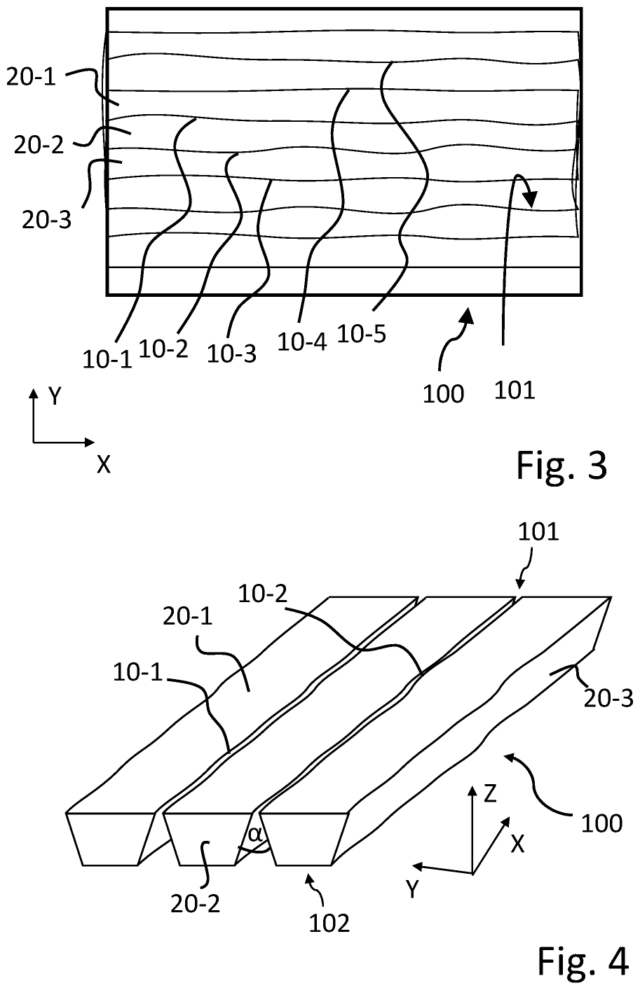

FIG. 3 a plan view of a three-dimensionally flexurally deformable surface element produced using a method according to the invention,

FIG. 4 a perspective cross-sectional view of a section of the three-dimensionally flexurally deformable surface element shown in FIG. 3,

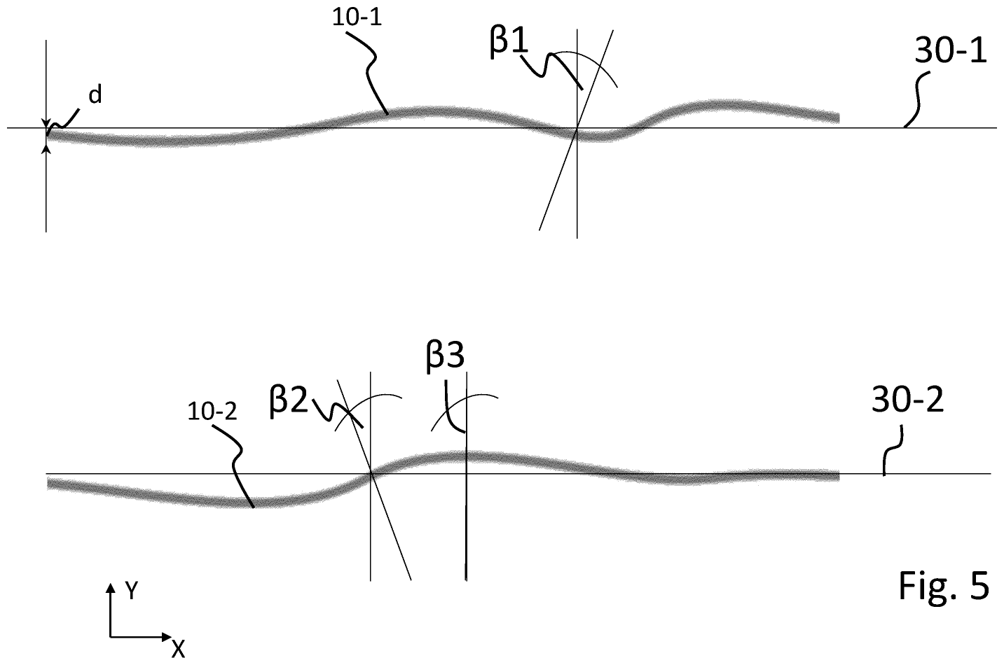

FIG. 5 a detail view of a plan view of joints of a three-dimensionally flexurally deformable surface element produced using the method according to the invention,

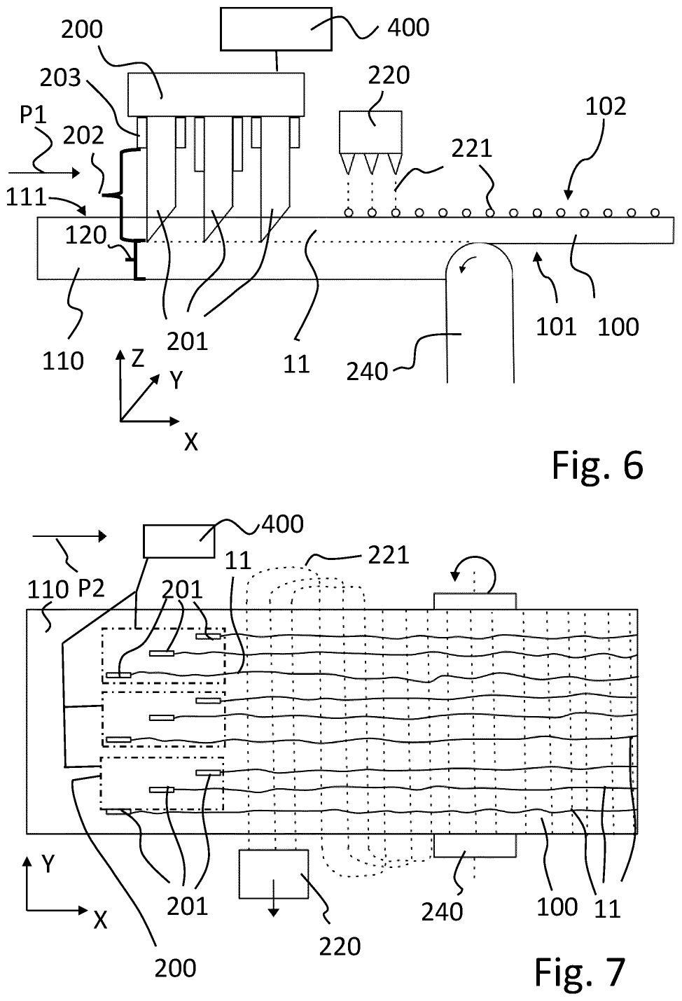

FIG. 6 a depiction of a method for producing a three-dimensionally flexurally deformable surface element according to one embodiment for illustrative purposes,

FIG. 7 a further illustrative depiction of the method illustrated in FIG. 6 in which a workpiece used in the method is shown in a plan view,

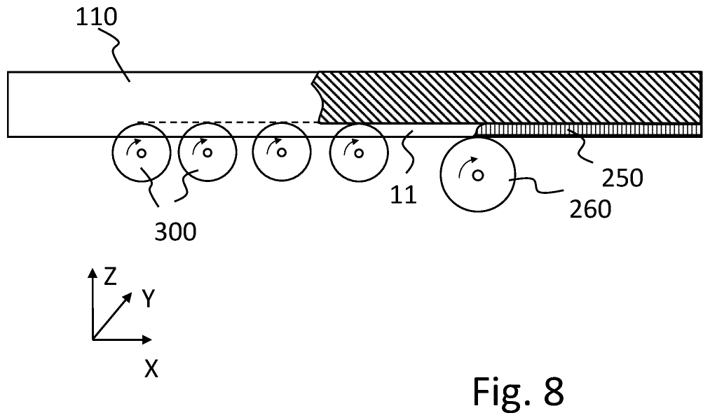

FIG. 8 an illustrative depiction of a method for producing a three-dimensionally flexurally deformable surface element according to one embodiment,

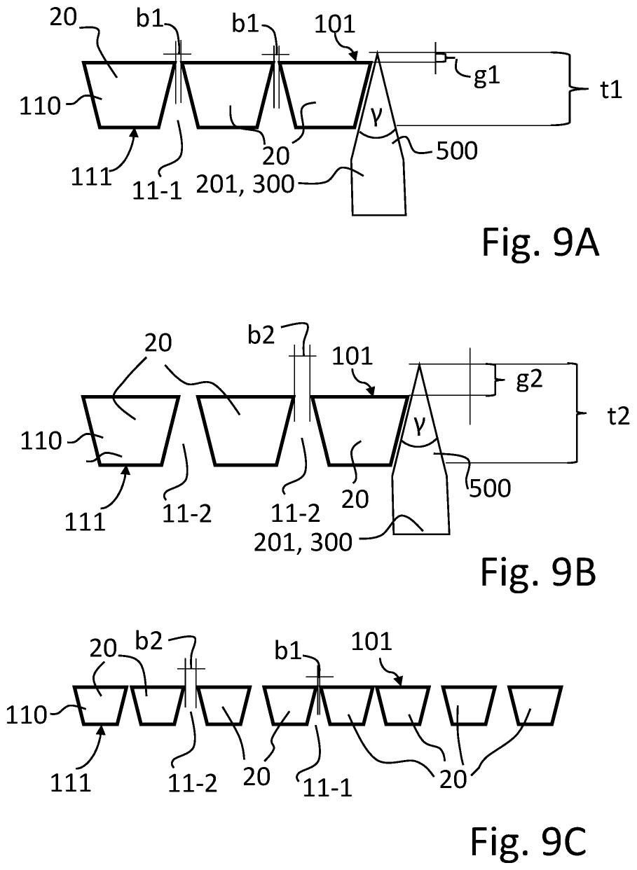

FIG. 9 depictions illustrating the effects of different scoring blade or roller blade penetration depths into a workpiece in one embodiment of a method according to the invention, and

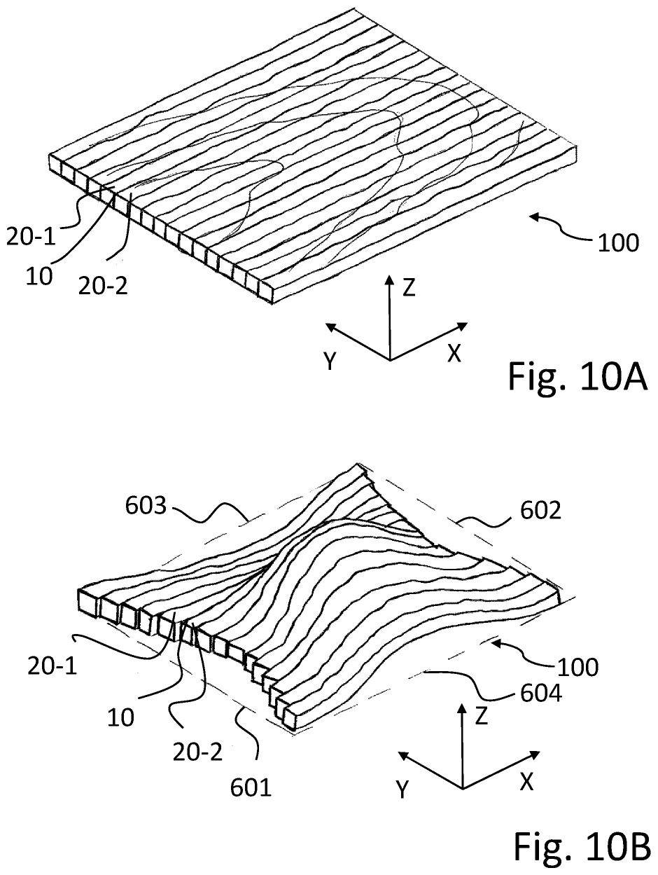

FIG. 10 depictions of a three-dimensionally flexurally deformable surface element produced by means of the inventive method.

FIG. 3 shows a plan view of a visible side 101 of a three-dimensionally flexurally deformable surface element 100 produced using a method according to the invention and FIG. 4 shows a perspective cross-sectional view of a section of the three-dimensionally flexurally deformable surface element 100 shown in FIG. 3. The surface element 100 comprises a plurality of joints 10-1, 10-2, 10-3, 10-4, 10-5 between strips 20-1, 20-2, 20-3 of wood which extend substantially along the X-direction illustrated in FIG. 3 although not in a straight line and not parallel to one another but rather in an irregular undulation. The shape of the joints 10-1, 10-2, 10-3, 10-4, 10-5 corresponds in particular to the shape of the grooves introduced into the workpiece by means of the inventive method for producing a three-dimensionally flexurally deformable surface element 100, in particular from a rear side of the workpiece or from the visible side 101 of the finished three-dimensionally flexurally deformable surface element, and can also be seen on the visible side 101 of the finished three-dimensionally flexurally deformable surface element 100. In other words, at least sections of the joints 10-1, 10-2, 10-3, 10-4, 10-5 formed in the three-dimensionally flexurally deformable surface element 100 correspond to the grooves made in the workpiece. The schematically depicted rear side 102 of the three-dimensionally flexurally deformable surface element 100 shown in FIG. 4 can be formed by a transverse bond not illustrated in FIG. 4, whereby the rear side of the workpiece corresponds to the rear side 102 of the three-dimensionally flexurally deformable surface element 100 without the transverse bond applied after the grooves having been introduced into the workpiece.

As illustrated in FIG. 3, the joints 10-1, 10-2, 10-3, 10-4, 10-5, or respectively the grooves introduced into the workpiece, exhibit an irregular undulation in the plan view of the visible side 101. In a non-illustrated embodiment, the joints 10-1, 10-2, 10-3, 10-4, 10-5 or grooves introduced into the workpiece can also exhibit contiguous rectilinear sections in plan view which extend in different directions. Furthermore, the joints 10-1, 10-2, 10-3, 10-4, 10-5 or grooves introduced into the workpiece can be designed so as to exhibit at least sections of irregular undulation and/or contiguous sections extending in different directions in plan view.

Generally speaking, the grooves can be introduced into the workpiece from the rear side of the workpiece and/or from the visible side 101 by means of scoring blades and/or roller blades and/or at least one laser and/or waterjet cutting using a jet of water and/or machining, in particular sawing and/or milling, with a machining tool.

According to one embodiment, the grooves are introduced into the workpiece by means of scoring blades and/or roller blades. According to one embodiment, a hardness of the scoring blades and/or the roller blades, in particular of a material thereof, and/or a material strength of the scoring blades and/or the roller blades and/or a free length of the scoring blades and/or roller blades and/or a cutting edge geometry, particularly an edge angle and/or bevel angle of the scoring blades and/or roller blades, and/or a ductility and/or an elasticity and/or a resilience of the scoring blades and/or the roller blades and/or an inclination angle of the scoring blades and/or roller blades with respect to the workpiece and/or one or more materials from which the scoring blades and/or the roller blades are formed, and/or a position and/or orientation of the scoring blades and/or roller blades and/or a mount of the scoring blades and/or roller blades when the grooves are introduced into the workpiece depending on type of wood and/or the hardness of the corresponding workpiece section and/or the local course of the wood fibers in said workpiece section and/or a global course of the wood fibers and/or a degree of plasticization of the wood of the workpiece is thereby actively selected such that during the introduction of the grooves into the workpiece, the scoring blades and/or the roller blades are passively deflected and/or twisted, substantially within known limits, particularly within permissible limits determined by a material of the workpiece and properties of a tool comprising the scoring blades and/or roller blades and with which the grooves are introduced into the workpiece, and thus in particular follow the course of the wood fibers. The scoring blades/roller blades in particular only follow the course of the wood fibers to a certain extent at which the movement of the scoring blades/roller blades is prevented from further following by means of being fixed by the mount, in particular a blade holder described below, which holds one or more of the scoring blades/roller blades and/or a below-described stabilization device designed for example as a sleeve and/or comprising clamping jaws in order to limit the free length of the scoring blades/roller blades. In the event of impermissible deviations, the wood fiber is then cut through. In particular, the passive deflection and/or twisting of the scoring blades and/or roller blades thereby at least contributes to the forming of the at least in part irregular undulation of the grooves or grooves having contiguous sections extending in different directions in plan view.

The different deflection and/or twisting of the scoring blades and/or roller blades depending on the section of the workpiece into which a section of a groove is introduced is caused by different hardnesses of the wood in different sections of the workpiece and/or the local course of the wood fibers in said section of the workpiece and/or the global course of the wood fibers and/or the degree of plasticization of the wood of the workpiece.

This in particular takes advantage of the fact that the hardness of the wood, as determined by the type of wood, among other things, varies depending on a local bulk density of the workpiece which is higher in the area of a branch, for example, than in other areas and/or a degree of plasticization of the workpiece or respectively the wood thereof, which can vary by wood moisture and/or temperature of the workpiece, and the local grain orientation subject to the presence of a branch, the wood fibers of which run differently, in particular perpendicular, to the wood fibers surrounding the branch and/or a length of the grain, and that the scoring blades/roller blades substantially follow the least resistance when the grooves are being introduced and are deflected and/or twisted in accordance with the variation in the hardness of the wood and/or the variation in the grain orientation within permissible limits as determined by the material of the workpiece and the properties of the tool. The scoring blades/roller blades in particular only follow the course of the wood fibers to a certain extent at which the movement of the scoring blades/roller blades is prevented from further following by means of being fixed, for example by means of a blade holder to be described below, and/or a below-described stabilization device. In the event of impermissible deviations, the wood fiber is then cut through.

In the embodiment illustrated in FIG. 4, the grooves are introduced in a V-shape, for example using wedge-shaped scoring blades and/or roller blades, wherein an opening angle α in the direction of the rear side of the workpiece of the V-shaped grooves introduced from the rear side of the workpiece can amount to 0°<α≤25°, preferably 0°<α≤20°, further preferably 0°<α≤15°. In a non-illustrated embodiment, the grooves can also be introduced into the workpiece such that they exhibit a profile deviating from the V-shape.

Preferentially, the grooves are introduced into the workpiece such that a distance measured in a width direction of the grooves, the Y-direction in FIG. 3, between respective adjacent grooves along a longitudinal direction of the grooves, the X-direction in FIG. 3, varies so that also the distance measured in the width direction of the joints 10-1, 10-2, 10-3, 10-4, 10-5 of the three-dimensionally flexurally deformable surface element 100, the Y-direction in FIG. 3, between respective adjacent joints 10-1, 10-2, 10-3, 10-4, 10-5 varies along a longitudinal direction of the joints 10-1, 10-2, 10-3, 10-4, 10-5, the X-direction in FIG. 3.

Further preferentially, the grooves are introduced into the workpiece in such a way that the shapes of sections extending in the longitudinal direction, or X-direction respectively, and corresponding to one another along the longitudinal direction, or X-direction respectively, differ in the plan view of the workpiece so that the shapes of corresponding sections of different joints 0-1, 10-2, 10-3, 10-4, 10-5 extending in the longitudinal direction, or X-direction, and corresponding to one another along the longitudinal direction, or X-direction, in the plan view of the visible side 101 of the three-dimensionally flexurally deformable surface element 100 also differ.

FIG. 5 shows a detail view of a plan view of joints of a three-dimensionally flexurally deformable surface element produced using the inventive method.

As illustrated in FIG. 5, two adjacent grooves are introduced into an exposed surface of the workpiece according to the inventive method, for example from a rear side of the workpiece, which are visible on a visible side 101 opposite from the rear side of the workpiece as joints 10-1, 10-2 in the three-dimensionally flexurally deformable surface element 100. Furthermore, FIG. 5 shows virtual lines 30-1, 30-2; i.e. only imaginary, not actually physically present lines, which extend in the X-direction on the visible side 101, or in the visible surface of the workpiece or the three-dimensionally flexurally deformable surface element 100 respectively. The grooves are thereby introduced, or the joints 10-1, 10-2 respectively designed, such that at each point of a respective groove/joint 10-1, 10-2, an angle β (β1, β2, β3) between a respective normal of each groove/joint 10-1, 10-2 and a normal of a respective virtual straight line 30-1, 30-2 associated therewith is in the range of −15°≤β≤+15°, particularly in the range of −5°<β<+5°.

The grooves are thereby preferentially introduced into the workpiece or the respectively designed joints 10-1, 10-2 such that over the entire length of the groove/joint 10-1, 10-2, a distance d, measured along a width direction Y of the groove/joint 10-1, 10-2, between each groove/joint 10-1, 10-2 and a respective virtual straight line 30-1, 30-2 associated therewith is less than 30%, preferentially less than 20%, particularly preferentially less than 10%, of a distance of the virtual straight line 30-1, 30-2 associated with the respective groove/joint 10-1, 10-2 and a virtual straight line 30-1, 30-2 associated with an adjacent groove/joint 10-1, 10-2 to the respective groove/joint 10-1, 10-2.

For example, in the embodiment illustrated in FIG. 5, the β1 angle is −2°, the β2 angle is +5°, the β3 angle is +/−0°, a distance between the groove/joint 10-1 and the virtual straight line 30-1 at the point where the groove/joint 10-1 forms the β1 angle with the virtual line 30-1 is +0.03 mm, a distance between the groove/joint 10-2 and the virtual straight line 30-2 at the point where the groove/joint 10-2 forms the β2 angle with virtual straight line 30-2 is +/−0 mm, and a distance between the groove/joint 10-2 and the virtual straight line 30-2 at the point where the groove/joint 10-2 forms the β3 angle with virtual straight line 30-2 is +0.08 mm.

FIG. 6 and FIG. 7 show depictions illustrating a method for producing a three-dimensionally flexurally deformable surface element, wherein FIG. 6 shows a cross-sectional view of the workpiece 110 and FIG. 7 shows a plan view of the workpiece 110.

With reference to FIG. 6 and FIG. 7, a workpiece 110, for example a veneer, in particular a beech veneer, having for example a thickness of 1.2 mm and the fibers of which preferably run substantially along the X-direction depicted in FIGS. 6 and 7, is provided and moved along the X-direction by means of a transport mechanism not shown in FIGS. 6 and 7, as illustrated by the P1 arrow in FIG. 6 and the P2 arrow in FIG. 7. It thereby traverses a scoring blade gate with a blade carrier 200 or holder 200 and scoring blades 201 which protrude downward from the blade carrier 200; i.e. in the negative Z-direction.

A lateral distance of the scoring blades 201 measured in the Y-direction can thereby be 1.0 mm and an offset of the scoring blades 201 measured along the X-direction 6 mm. When traversing the scoring blade gate, grooves 11, for example 1 mm deep grooves 11, are cut or respectively introduced into the workpiece 110 by the scoring blades 201 at a distance of, for example, 1 mm from a rear side 111 of the workpiece 110, these being visible as joints on the visible side 101 of the three-dimensionally flexurally deformable surface element 100 opposite from the rear side 111 of the workpiece 110 and exhibiting the shape described with reference to FIGS. 3, 4 and 5. The remaining 0.2 mm forms the temporary connection 120 of the grooved areas.

A free length 202 of the scoring blades 201 can be limited by a stabilizing device 203 designed for example as a sleeve and/or comprising clamping jaws. As illustrated in FIG. 6, preferably the free length 202 of at least some of the scoring blades 201 differs. Due to the differing free length 202, the different scoring blades 201 are deflected to different degrees under otherwise identical conditions, in particular the same hardness of the workpiece 110 section into which the grooves 11 are introduced, which results in differently shaped grooves 11 being respectively produced. In particular, scoring blades 201 having a greater free length 202 are thereby deflected to a greater extent than scoring blades 201 with a smaller free length 202.

The scoring blades 201 and/or the blade carriers 200 can additionally be mounted with play so that their position and orientation can vary slightly during the introduction of the grooves 11 into the workpiece 110. Additionally or alternatively, a material and/or hardness and/or material strength, the free length and/or a cutting edge geometry, particularly an edge angle and/or bevel angle of the scoring blades 201, and/or a ductility and/or an elasticity and/or a resilience of the scoring blades 201 and/or an inclination angle of the scoring blades 201 with respect to the workpiece 110 and/or one or more materials from which the scoring blades 201 are formed, and/or a clamping force of the scoring blades 201 applied by the clamping jaws, in particular adjacent scoring blades 201 depending on the type of wood and/or the degree of plasticization of the wood of the workpiece 110 and/or the hardness of the corresponding workpiece 110 section and/or the local course of the wood fibers in said workpiece 110 section and/or a global course of the wood fibers can be actively selected such that during the introduction of the grooves 11 into the workpiece 110, the scoring blades are passively deflected and/or twisted, substantially within known limits, particularly within permissible limits determined by a material of the workpiece 110 and properties of a tool comprising the scoring blades 201 and with which the grooves 11 are introduced into the workpiece 110, and thus in particular follow the course of the wood fibers.

Additionally or alternatively, by means of one or more not-shown motors, in particular electric motors, e.g. servomotors and/or stepper motors controlled by a control unit 400, the blade carriers 200 can be moved along the Y-direction, in particular made to oscillate along the Y-direction, for example using an eccentric, or respectively moved back and forth periodically along the Y-direction at a predetermined frequency and/or turned in the X-Y plane and/or the X-Z plane as the grooves 11 are being introduced into the workpiece 110, wherein in the latter case, the angle of inclination of the scoring blades 201 can be changed in order to change a cutting force of the respective scoring blade 201. So doing enables further variability in the variance of shapes of the respective grooves 11 introduced into the workpiece 110.

After traversing the scoring blade gate, a transverse bond 221, in particular a polymer in the form of a thermoplastic or an adhesive, or a liquid polymer, in particular a liquid plastic, preferably reinforced with a multifilament and/or fibers, in particular short fibers, is applied to the workpiece 110, particularly its rear side 111, by means of a transverse bond application unit 220 which is moved back and forth in the width direction Y over the workpiece 110, particularly its rear side 111 into which the grooves 11 are introduced in order to form the transverse bond for joining the areas of the workpiece 110 divided or respectively separated by the grooves 11.

In the embodiment shown in FIG. 7, the transverse bond 221 is applied substantially perpendicular to the longitudinal fiber direction or the virtual straight lines 30-1, 30-2 respectively. To that end, according to one embodiment, the not-shown transport mechanism for moving the workpiece 110 along the X-direction is in each case stopped while the transverse bond application unit 220 is moved over the workpiece 110 in the direction of the positive Y-direction or the direction of the negative Y-direction respectively. According to another embodiment in which the transport mechanism for moving the workpiece 110 along the X-direction is continuously operated in order to move the workpiece at a speed v in the X-direction during the application of the transverse bond 221 using a movement of the transverse bond application unit 220 in the direction of the positive Y-direction or the direction of the negative Y-direction, the transverse bond application unit 220 is simultaneously moved at a speed v in the X-direction.

In other not-shown embodiments, the transverse bond 221 can also be applied obliquely to the longitudinal fiber direction; i.e. at an angle & in a range of 0°<<<90° with respect to the longitudinal fiber direction, for example at a 45° angle to the longitudinal fiber direction or the virtual straight lines 30-1, 30-2 respectively. In this case, the displaceability in one direction along the grooves 11 or joints 10 is substantially blocked while the displaceability in the other direction can for example be increased compared to the displaceability at a 90° angle.

After the application of the transverse bond 221, and preferably after the applied transverse bond 221 having solidified, the temporary connection 120, preferably along with a safety margin of e.g. 0.1 mm, is ground off by means of a grinding apparatus 240, leaving a 0.9 mm thick three-dimensionally flexurally deformable surface element 100.

FIG. 8 shows a depiction illustrative of a method for producing a three-dimensionally flexurally deformable surface element according to one embodiment.

With reference to FIG. 8, a workpiece 110, in particular a scantling of cherry wood measuring 100×250×1500 mm³, is provided and is moved along the X-direction by means of a transport mechanism not illustrated in FIG. 8 such that it traverses four roller blade shafts consecutively arranged along the X-direction, each containing roller blades 300 spaced 1.2 mm apart, wherein the roller blades are each laterally offset by 0.3 mm; i.e. along the Y-direction, so that the thusly created grooves 11, which exhibit the shape described with reference to FIGS. 3, 4 and 5, are substantially at a spacing of 0.3 mm. The roller blades 300 are arranged such that they penetrate 0.4 mm to 4 mm into the workpiece 110, whereby 0.4 mm to 4 mm deep grooves 11 are cut into the workpiece 110. Subsequently, a PU dispersion adhesive press 260 presses PU dispersion adhesive 250 into the grooves 11, which quickly solidifies due to the low volume of adhesive in the grooves 11 in order to form the transverse bond. In one not-shown embodiment, the transverse bond can additionally or alternatively be formed using the transverse bond application unit 220 described with reference to FIGS. 6 and 7.

At least some of the roller blades 300 can thereby have different hardnesses and/or different free lengths and/or be directly or indirectly mounted with play by way of a blade carrier or holder with clearance which holds the roller blades 300, analogous to the scoring blades 201 described with reference to FIGS. 6 and 7. Furthermore, the roller blades 300 and/or their blade carriers can be moved along the Y-direction, in particular made to oscillate along the Y-direction, for example using an eccentric, or respectively moved back and forth periodically along the Y-direction at a predetermined frequency and/or turned in the X-Y plane as the grooves 11 are being introduced into the workpiece 110 by means of one or more not-shown motors, in particular electric motors, e.g. servomotors and/or stepper motors controlled by a not-shown control unit in order to achieve the variance of the shapes of the grooves 11 respectively introduced into the workpiece 110.

The workpiece 110 thereafter traverses a not-shown finishing machine in which a 0.3 mm thick three-dimensionally deformable surface element is measured off from the grooved side of the workpiece. This process is repeated until the entire scantling is processed. The three-dimensionally flexurally deformable surface element can be further processed, for example to produce a highly three-dimensionally deformed case.

According to one non-illustrated embodiment, a composite material is produced from a 0.5 mm thick birch burl veneer, to the upper side of which a 0.5 mm thick soft PVC film is affixed by means of an acrylate pressure-sensitive adhesive, and to the lower side of which a 0.4 mm thick polyacrylate film is affixed by means of a fully cured polyurethane adhesive. This composite material is grooved from the underside to a depth of 1 mm and at a spacing of 0.8 mm via scoring blades in accordance with the embodiment illustrated in FIGS. 6 and 7. The polyacrylate film seals off the birch grain veneer and thereby stabilizes it. The grooves are subsequently filled by means of hot melt adhesive. The PVC film is then pulled off the composite. The contact adhesive is configured to only effect a pressure sensitive bond able to be broken with moderate force, whereby the contact adhesive fully detaches from the veneer. A three-dimensionally deformable surface element thus results. The surface elements can optionally be stored between the grooving and the drawing off of the PVC film. The PVC film thereby takes on the function of a protective film. The PVC film can be cleaned of adhesive and reused as needed.

FIG. 9 illustrates the effects of a different penetration depth of scoring blades or roller blades into the workpiece according to one embodiment of the inventive method.

In the example illustrated in FIG. 9A, a scoring blade 201 or a roller blade 300, its blade 500 exhibiting a wedge-shaped cross section with a wedge angle γ, penetrates from a rear side 111 of the workpiece 110, of which only the portion of the workpiece 110 contained in the finished three-dimensionally flexurally deformable surface element 100 is shown, into the workpiece 110 at such a penetration depth t1 that it protrudes by a length g1 beyond the three-dimensionally flexurally deformable surface element 100 to be produced, or the visible side 101 of the three-dimensionally flexurally deformable surface element 100 to be produced respectively, so as to form the groove 11-1 in the workpiece 110. An opening angle α of the introduced groove 11-1 thereby substantially corresponds to wedge angle γ. At this penetration depth t1, a groove 11-1 with a width b1 is created on the visible side 101, measured along the width direction of the groove 11-1.

Should, however, as illustrated in FIG. 9B, the scoring blade 201 or the roller blade 300 penetrate from the rear side 111 with such a penetration depth t2 as to protrude beyond the three-dimensionally flexurally deformable surface element 100 to be produced, or the visible side 101 of the three-dimensionally flexurally deformable surface element 100 to be produced respectively, by a length g2, which is greater than length g1, in order to form the groove 11-2 in the workpiece 110, a groove 11-2 is created on the visible side 101 which has a width b2, measured along the width direction of the groove 11-2, which is greater than the width b1 of the groove 11-1 illustrated in FIG. 9A.

As illustrated in FIG. 9C, grooves 11-1, 11-2 having different widths b1, b2 can in this way be created on the visible side 101 of the three-dimensionally flexurally deformable surface element 100 to be produced. Due to lower frictional forces and/or greater free length of the corresponding section of the transverse bond, adjacent strips 20 of wood separated by a groove 11-2 of width b2 are thereby more easily displaceable against each other than strips 20 of wood separated by a groove 11-1 of width b1.

FIG. 10 shows depictions of a three-dimensionally flexurally deformable surface element produced by means of the inventive method, wherein FIG. 10A shows the three-dimensionally flexurally deformable surface element in a first state directly after production and FIG. 10B shows the three-dimensionally flexurally deformable surface element in a second state in which the originally produced three-dimensionally flexurally deformable surface element has been three-dimensionally deformed.

As described above and illustrated in FIG. 10A, the three-dimensionally flexurally deformable surface element 100 comprises multiple strips 20-1, 20-2 of wood, wherein two respectively adjacent strips 20-1, 20-2 of wood from the plurality of strips are separated by a joint 10 with an irregular undulation and/or contiguous rectilinear sections extending in different directions. The multiple strips 20-1, 20-2 of wood are connected by means of an above-described and not depicted in FIGS. 10A and 10B transverse bond, whereby adjacent strips 20-1, 20-2 of wood are displaceable relative to one another as described above.

In the three-dimensionally deformed state shown in FIG. 10B, the ends of the multiple strips 20-1, 20-2 are displaced to different extents along the X-direction subject to a degree of deformation of the corresponding section of the three-dimensionally flexurally deformable surface element 100 in comparison to the first state illustrated in FIG. 10A and implied in FIG. 10B by dashed lines 601, 602. Simultaneously with the displacement of the ends of the multiple strips 20-1, 20-2 along the X-direction, sections of the multiple strips 20-1, 20-2 are also displaced along the Z-direction in comparison to the first state illustrated in FIG. 10A and implied in FIG. 10B by dashed lines 603, 604.

What is claimed is:

1. A method for producing a three-dimensionally flexurally deformable surface element (3D surface element) from wood or wood composite material in which a workpiece made of wood, layered wood or a composite of wood and one or more further surface materials is used, its thickness being greater, in particular at least 5% greater, than the thickness of the 3D surface element to be produced, wherein narrow grooves spaced apart from one another are introduced into the workpiece, wherein the groove depth is in each case greater than or equal to the thickness of the 3D surface element and less than the thickness of the workpiece, the portion of the workpiece which exceeds the thickness of the 3D surface element to be produced then being separated from the remaining 3D surface element or otherwise processed such that there is at least temporarily no solid cohesion of the areas separated by grooves and the areas of the workpiece separated by grooves are fixed to each other and/or to a support by a transverse bond prior to, during or after separation from the workpiece, wherein
at least two adjacent grooves, in particular all of the grooves, are introduced into the workpiece in such a way that at least sections exhibit an irregular undulation and/or contiguous rectilinear sections extending in different directions in a plan view of the workpiece.

2. The method according to claim 1, wherein the at least two adjacent grooves are introduced into the workpiece such that a spacing of the at least two adjacent grooves measured in a width direction of the grooves varies along a longitudinal direction of the grooves.

3. The method according to claim 1, wherein the grooves are introduced into the workpiece in such a way that there is an angle β in the range of −15°≤β≤+15°, in particular in the range of −5°≤β≤+5°, between a local normal of each groove and a respective normal of a virtual straight line associated with the respective groove at each point of the respective groove.

4. The method according to claim 1, wherein the grooves are introduced into the workpiece such that over the entire length of the groove, there is a distance between each groove and a respective virtual straight line associated therewith of less than 30%, in particular less than 20% or less than 10%, of a distance between the virtual straight line associated with the respective groove and a virtual straight line associated with an adjacent groove of the respective groove.

5. The method according to claim 1, wherein the grooves are introduced into the workpiece such that sections of different grooves extending in the longitudinal direction and corresponding to one another in the longitudinal direction are of different shape in the plan view of the workpiece.

6. The method according to claim 1, in which the grooves are introduced into the workpiece by means of scoring blades and/or roller blades and/or at least one laser and/or waterjet cutting using a jet of water and/or machining, in particular sawing and/or milling, with a machining tool.

7. The method according to claim 6, in which the scoring blades and/or the roller blades are configured so as to be passively deflected and/or passively twisted during the introduction of the grooves into the workpiece subject to a hardness of the corresponding section of the workpiece and/or a local course of the wood fibers in said section of the workpiece, and/or a position and/or orientation of the scoring blades and/or the roller blades and/or a mount of the scoring blades and/or roller blades is passively changed during the introduction of the grooves into the workpiece subject to the hardness of the corresponding section of the workpiece and/or the local course of the wood fibers in said section of the workpiece and/or actively changed in order to produce the at least sectionally irregularly undulating shape of the grooves or contiguous rectilinear sections of the grooves extending in different directions in the plan view of the workpiece respectively by the passive deflection and/or twisting of the scoring blades and/or the roller blades and/or the active or passive changing of the position and/or orientation of the scoring blades and/or the roller blades and/or the mount of the scoring blades and/or roller blades.

8. The method according to claim 7, in which a hardness of the scoring blades and/or the roller blades, in particular of a material thereof, and/or a material strength of the scoring blades and/or the roller blades and/or a free length of the scoring blades and/or roller blades and/or a cutting edge geometry, particularly an edge angle and/or bevel angle of the scoring blades and/or roller blades, and/or a ductility and/or an elasticity and/or a resilience of the scoring blades and/or the roller blades and/or an inclination angle of the scoring blades and/or roller blades with respect to the workpiece and/or one or more materials from which the scoring blades and/or roller blades are formed, and/or the position and/or the orientation of the scoring blades and/or roller blades and/or the mount of the scoring blades and/or roller blades when the grooves are introduced into the workpiece depending on type of wood and/or a degree of plasticization of the wood of the workpiece and/or the hardness of the corresponding section of the workpiece and/or the local course of the wood fibers in said section of the workpiece and/or a global course of the wood fibers is actively selected such that during the introduction of the grooves into the workpiece, the scoring blades and/or the roller blades are passively deflected and/or twisted within known limits, particularly within permissible limits determined by a material of the workpiece and properties of a tool comprising the scoring blades and/or roller blades and with which the grooves are introduced into the workpiece.

9. The method according to claim 7, wherein the position, in particular perpendicular to the virtual straight line, and/or the alignment of the scoring blades and/or the roller blades and/or the mount of the scoring blades and/or roller blades and/or a position and/or alignment of the laser and/or the water jet and/or the machining tool is changed as the grooves are being introduced into the workpiece, in particular using a motor, particularly a servomotor and/or stepper motor, and/or an eccentric.

10. The method according to claim 6, in which the grooves are introduced into the workpiece by means of scoring blades and/or roller blades, the blades of which are wedge-shaped in cross section, in particular along a width direction of the groove to be introduced, such that at least two adjacent scoring blades and/or roller blades have a different penetration depth into the workpiece.

11. Use of a method according to claim 1 for producing a layered two- or three-dimensionally formed piece or for laminating a two- or three-dimensionally formed piece.

12. A three-dimensionally flexurally deformable surface element from wood or wood composite material, comprising a plurality of strips of wood, layered wood or a composite of wood and one or more further surface materials which are fixed to one another and/or to a support by a transverse bond and separated by joints, wherein at least sections of at least two adjacent joints, in particular all of the joints, exhibit an irregular undulation and/or contiguous rectilinear sections extending in different directions in a plan view of the three-dimensionally flexurally deformable surface element.

13. The three-dimensionally flexurally deformable surface element according to claim 12, wherein a spacing of the at least two adjacent joints measured in a width direction of the joints varies along a longitudinal direction of the joints.

14. The three-dimensionally flexurally deformable surface element according to claim 12, wherein there is an angle β in the range of −15°≤β≤+15°, in particular in the range of −5°≤β≤5°, between a local normal of each joint and a respective normal of a virtual straight line associated with the respective joint at each point of the respective joint.

15. The three-dimensionally flexurally deformable surface element according to claim 12, wherein a distance between each joint and a respective virtual straight line associated therewith is less than 30%, in particular less than 20% or less than 10%, of a distance between the virtual straight line associated with the respective joint and a virtual straight line associated with an adjacent joint of the respective joint over the entire length of the joint.

16. The three-dimensionally flexurally deformable surface element according to claim 12, wherein the sections of different joints extending in the longitudinal direction and corresponding to one another in the longitudinal direction are of different shape in the plan view of the three-dimensionally flexurally deformable surface element.

17. A layered two- or three-dimensional formed piece comprising at least one three-dimensionally flexurally deformable surface element according to claim 12.
